(19) United States
(12) Patent Application Publication
(10) Pub. No.: US 2003/0214071 A1
(43) Pub. Date: Nov. 20, 2003

(54) Mold

(76) Inventors: Tomoyuki Ogawa, Kakamigahara-shi (JP); Hisashi Takenouchi, Higashiosaka-shi (JP)

Correspondence Address: Marsh Fischmann & Breyfogle LLP, Suite 411, 3151 South Vaughn Way, Aurora, CO, 80014, US

(21) Appl. No.: 10/390,145

(22) Filed: Mar. 17, 2003

(30) Foreign Application Priority Data
May 15, 2002 (JP) PAT. 2002-140524
Jul. 8, 2002 (JP) PAT. 2002-199055

(51) Int. Cl. B29C 45/14

(52) U.S. Cl. 264/255; 425/112; 425/451.7

(57) ABSTRACT

A mold includes a body, a first movable member and a second movable member. The body defines a first cavity. The first movable member defines a second cavity. The first movable member reciprocates along a predetermined movement axis with respect to the mold. The second movable member is movable along the movement axis with respect to the first movable member in the body for selectively connecting and disconnecting the second cavity and the first cavity according to the movement of the second movable member. A first material is supplied to one of the first cavity and the second cavity with the first and second cavities disconnected from each other. Then a second material is supplied to the other one of the first and second cavities with the first and second cavities connected to each other.

### BACKGROUND OF THE INVENTION

The present invention is related to a mold for supplying two or more kinds of materials into a cavity to form an integrally molded article, and more particularly to a mold for injection molding an integrally molded article using two kinds of high polymer materials.

Conventionally, when an integrally molded article is molded by two materials, for example, one fixed mold is used and a different movable mold is necessary for each material. Therefore, the mold clamping and the mold opening are necessary every time a different movable mold is used, and molding efficiency is decreased.

### SUMMARY OF THE INVENTION

The objective of the present invention is to provide a mold for molding an integrally molded article, which mold efficiently uses two or more than materials.

To achieve the above object, the present invention provides a mold for molding an integrally molded article using at least two kinds of materials. The mold includes a body, a first movable member and a second movable member. The body defines a first cavity. The first movable member defines a second cavity. The first movable member reciprocates along a predetermined movement axis with respect to the mold. The second movable member is movable along the movement axis with respect to the first movable member in the body for selectively connecting and disconnecting the second cavity and the first cavity according to the movement of the second movable member. A first material is supplied to one of the first cavity and the second cavity with the first and second cavities disconnected from each other. Then a second material is supplied to the other one of the first and second cavities with the first and second cavities connected to each other.

The present invention provides another a mold for molding an integrally molded article using at least two kinds of materials. The mold includes a body, a first movable member and a second movable member. The body defines a first cavity. The first movable member defines a second cavity. The first movable member moves with respect to the mold. The second movable member slides along the first movable member, while contacting the first movable member in the body. The second movable member selectively connects and disconnects the second cavity and the first cavity in accordance with the movement of the second movable member. A first material is supplied to one of the first cavity and the second cavity with the first and second cavities disconnected from each other. Then a second material is supplied to the other one of the first and second cavities with the first and second cavities connected to each other.

The present invention provides another a mold for molding an integrally molded article using at least two kinds of materials. The mold includes a body, a first movable member and a second movable member. The body defines a first cavity. The first movable member defines a second cavity. The second movable member is arranged on the first movable member in the body and movable with the first movable member and with respect to the first movable member for selectively connecting and disconnecting the second cavity and the first cavity. A first material is supplied to one of the first cavity and the second cavity with the first and second cavities disconnected from each other. Then a second material is supplied to the other one of the first and second cavities with the first and second cavities connected to each other.

The present invention provides another a mold for molding an integrally molded article using at least two kinds of materials. The mold includes a body, a first movable member and a second movable member. The body defines a first cavity. The first movable member defines a second cavity. The first movable member is movable with respect to the mold. The second movable member is movable in the body so as to be in contact with and apart from the first movable member for selectively connecting and disconnecting the second cavity and the first cavity in accordance with the movement of the second movable member. A first material is supplied to one of the first cavity and the second cavity with the first and second cavities disconnected from each other. Then a second material is supplied to the other one of the first and second cavities with the first and second cavities connected to each other.

The present invention also provides a manufacturing method for molding an integrally molded article using at least two kinds of materials. The method includes defining a first cavity by approaching a movable mold to a fixed mold; defining a second cavity by moving a first movable member with respect to the movable mold along a predetermined movement axis to a closed position; disconnecting a first cavity and a second cavity by moving the second movable member with respect to the first movable member along the movement axis to a disconnecting position while a first and a second cavities are formed; supplying a first material to one of the first and the second cavities while the second cavity is disconnected from the first cavity; connecting the first and the second cavities by moving the second movable member from the disconnecting position to an open position; supplying a second material to the other one of the first and the second cavities while the second cavity is connected to the first cavity; and releasing the first and the second cavities by separating the movable mold from the fixed mold and moving the first movable member and the second movable member from the closed position to the open position.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a partial cross-sectional view showing mold clamping of a mold according to a first embodiment of the present invention before a material is supplied to a cavity;

FIG. 2 is a partial cross-sectional view showing that a material is supplied to a first cavity of the mold shown in FIG. 1;

FIG. 3 is a partial cross-sectional view showing that a material is supplied to a second cavity of the mold shown in FIG. 2;

FIG. 4 is a partial cross-sectional view showing mold opening of the mold shown in FIG. 3;

FIG. 5 is a partial cross-sectional view showing mold clamping of a mold according to a second embodiment before a material is supplied to a cavity;

FIG. 6 is a partial cross-sectional view showing a material is supplied to a first cavity of the mold shown in FIG. 5;

FIG. 7 is a partial cross-sectional view showing a material is supplied to a second cavity of the mold shown in FIG. 6; and

FIG. 8 is a partial cross-sectional view showing mold opening of the mold shown in FIG. 7.

### DETAILED DESCRIPTION OF THE PREFERRED EMBODIMENTS

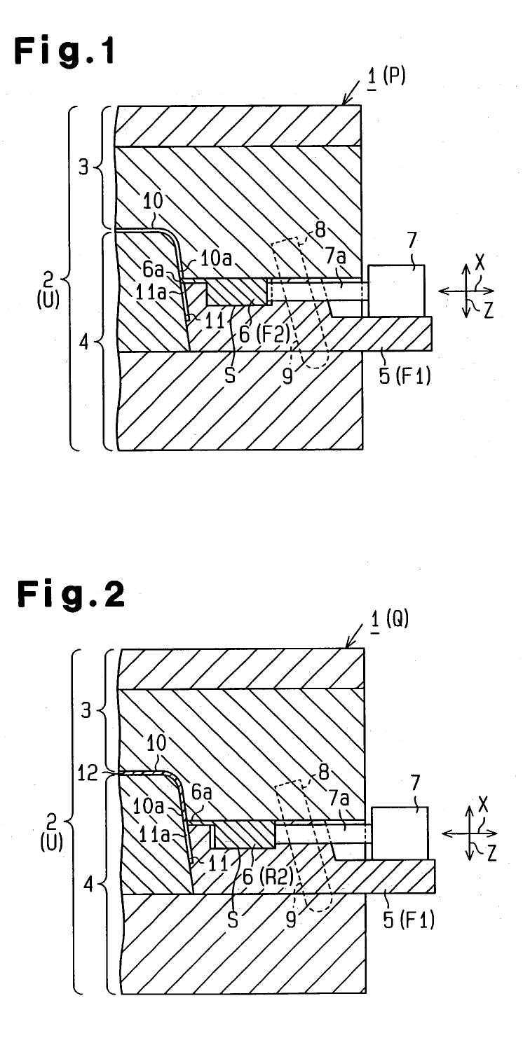

Hereinafter, an injection mold 1 according to a first embodiment of the present invention will be explained with reference to FIGS. 1-4.

A body 2 of the mold 1 shown in FIG. 1 comprises a fixed mold 3 that is arranged on an upper side in FIG. 1 and a movable mold 4 that is arranged on a lower side in FIG. 1. The movable mold 4 reciprocates along a vertical direction Z. FIGS. 1-3 show a mold clamping condition U (closed position) where the movable mold 4 approaches the fixed mold 3. FIG. 4 shows a mold opening condition D (open position) where the movable mold 4 is apart from the fixed mold 3.

A first movable member 5 is supported on an upper surface of the movable mold 4 that faces the fixed mold 3 so as to reciprocate along a horizontal movement axis X. A second movable member 6 having a extended portion 6a and a hydraulic cylinder 7 that serves as an actuator are placed on the first movable member 5. A piston rod 7a is connected to the second movable member 6. The second movable member 6 has a slide surface S that contacts the first movable member 5. The second movable member 6 moves along the horizontal movement axis X with respect to the first movable member 5 between a forward position F2 shown in FIG. 1 and a rear position R2 shown in FIGS. 2-4 in accordance with the movement of the piston rod 7a along the horizontal movement axis X.

A pin 8 that serves as a movement mechanism is fixed to the fixed mold 3. A hole 9 that serves as a movement mechanism is formed in the movable mold 4 and the first movable member 5. The pin 8 and the hole 9 are slanted with respect to the vertical direction Z and the movement axis of the movable mold 4. The pin 8 is inserted to and removed from the hole 9 in accordance with the movement of the movable mold 4 with respect to the fixed mold 3. More in detail, as shown in FIGS. 1-3, when the pin 8 is inserted to the hole 9 in accordance with the upward movement of the movable mold 4, the mold is in the mold clamping condition U and the first movable member 5 is moved to the forward position F1 (closed position) with the second movable member 6 and the hydraulic cylinder 7. As shown in FIG. 4, when the pin 8 is removed from the hole 9 in accordance with the downward movement of the movable mold 4, the mold is in the mold opening condition D, the first movable member 5 is moved to the rear position R1 (open position) with the second movable member 6 and the hydraulic cylinder 7.

In a first molding condition P shown in FIG. 1, each of the first and second movable members 5, 6 is positioned in the forward position F1, F2 respectively. In this condition, a first cavity 10 is formed between the fixed mold 3 and the movable mold 4 and a second cavity 11 is formed between the movable mold 4 and the first movable member 5. In the first molding condition P, the extended portion 6a of the second movable member 6 is extended between an end portion 10a of the first cavity 10 and an end portion 11a of the second cavity 11 to disconnect the end portion 11a of the second cavity 11 from the end portion 10a of the first cavity 10. On the other hand, when the second movable member 6 is moved from the forward position F2 (closed position) to the rear position R2 (open position) in the first molding condition P, the mold is in a second molding condition Q shown in FIG. 2. In the second molding condition Q, the extended portion 6a of the second movable member 6 withdraws from between the end portion 10a of the first cavity 10 and the end portion 11a of the second cavity 11. As a result, the first cavity 10 is released so that the end portion 11a of the second cavity 11 is communicated with the end portion 10a of the first cavity 10.

Next, a manufacturing method for manufacturing an integrally molded article 14 will be explained.

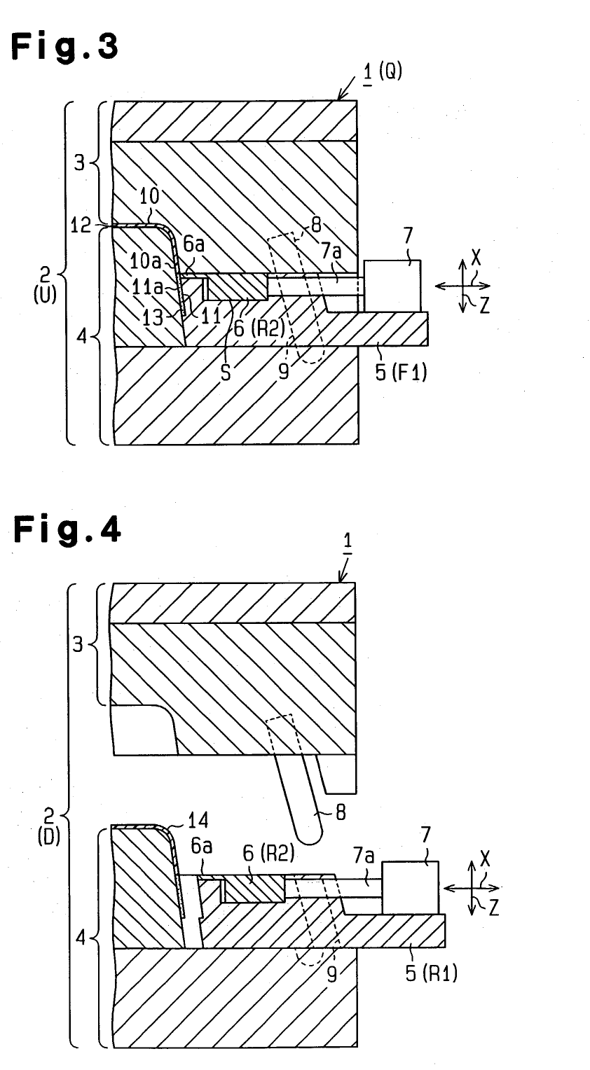

In the first molding condition P shown in FIG. 1, a melted first material 12 is supplied to only the first cavity 10 via a first passage (not shown) (refer to FIG. 2). Next, in the second molding condition Q shown in FIG. 2, a melted second material 13 is supplied to the second cavity 11 via a second passage (not shown) (refer to FIG. 3). As a result, as shown in FIG. 3, the second material 13 in the second cavity 11 is integrally connected with the first material 12 in the first cavity 10. Next, while the movable mold 4 moves downwardly so as to be apart from the fixed mold 3, the first movable member 5 is moved to the rear position R1 by the operation of the pin 8 and the hole 9. As shown in FIG. 4, in the mold opening condition D, the first and second movable members 5, 6 are separated from the integrally molded article 14 including the solidified first material 12 and the second material 13 and the molded article 14 can be taken out easily from the mold.

This embodiment has following advantages.

The molded article 14 including the first and the second materials 12, 13 can be formed efficiently by carrying out the mold clamping and the mold opening once with one mold 1. Moreover, the mold 1 of a compact and a simple structure is provided by arranging the first and the second movable members 5, 6 closer to each other.

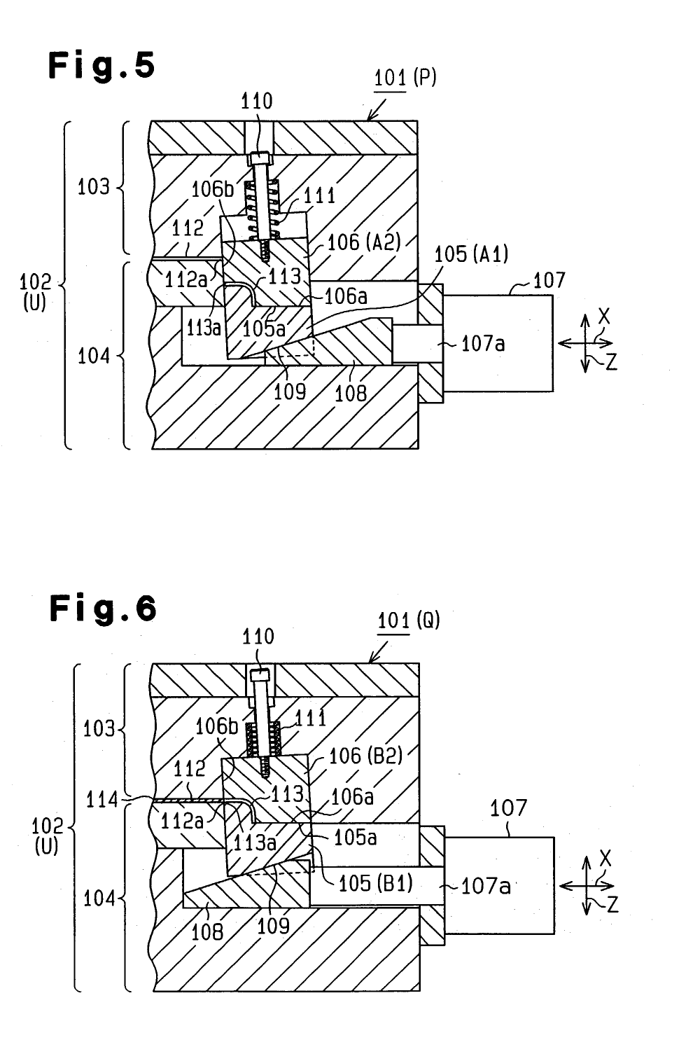

Next, an injection mold 101 according to a second embodiment of the present invention will be explained with reference to FIGS. 5-8.

A body 102 of a mold 101 shown in FIGS. 5-8 comprises a fixed mold 103 that is arranged on an upper side in the drawings and a movable mold 104 that is arranged on a lower side in the drawings. The movable mold 104 reciprocates along a vertical movement axis Z. FIGS. 5-7 show a mold clamping condition U (closed position) where the movable mold 104 approaches the fixed mold 103. FIG. 8 shows a mold opening condition D (open position) where the movable mold 104 is apart from the fixed mold 103.

A first movable member 105 is supported by the movable mold 104 between the movable mold 104 and the fixed mold 103 so as to reciprocate along the vertical movement axis Z. A second movable member 106 is supported by the fixed mold 103 between the movable mold 104 and the fixed mold 103 so as to reciprocate along the vertical movement axis Z.

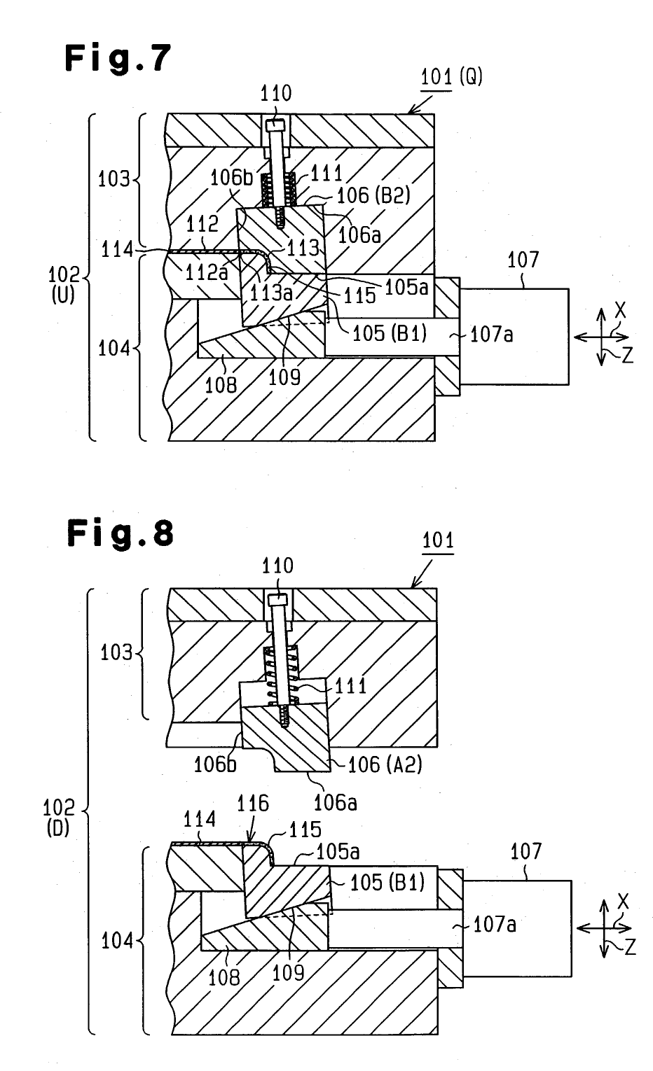

A hydraulic cylinder 107 that serves as an actuator is arranged on the movable mold 104. A conduction member 108 is arranged on a piston rod 107a of the hydraulic cylinder 107. The conduction member 108 has a slanted conduction surface 109 that contacts the first movable member 105. When the piston rod 107a of the hydraulic cylinder 107 moves along the horizontal direction X, the first movable member 105 moves along the vertical movement axis Z via the conduction member 108 between a lower position A1 shown in FIG. 5 and an upper position B1 shown in FIGS. 6-8. The second movable member 106 is hung from the fixed mold 103 by a rod 110 and urged toward the first movable member 105 by a compression coil spring 111 wound around the rod 110. The second movable member 106 is arranged at the lower position A2 by an elastic force of the compression coil spring 111 in the mold clamping condition U shown in FIG. 5 and the mold opening condition D (open position) shown in FIG. 8. The second movable member 106 is arranged at the upper position B2 against the elastic force of the compression coil spring 111 in the mold clamping condition U shown in FIGS. 6, 7. The second movable member 106 moves between the lower position A2 and the upper position B2.

In a first molding condition P shown in FIG. 5, a first cavity 112 is formed between the fixed mold 103 and the movable mold 104. The first movable member 105 is arranged at the lower position A1 and the second movable member 106 is arranged at the lower position A2. A part of a facing surface 105a of the first movable member 105 and a part of a facing surface 106a of the second movable member 106 are pressed with each other by the elastic force by the compression coil spring 111. A second cavity 113 is formed between portions of the facing surfaces 105a, 106a that do not contact with each other. A closing surface 106b of the second movable member 106 disconnects an end portion 113a of the second cavity 113 from an end portion 112a of the first cavity 112 at the lower position A2. When the first and the second movable members 105, 106 are moved to the upper positions B1, B2 respectively from the first molding condition P shown in FIG. 5, the mold is in a second molding condition Q shown in FIG. 6. In the second molding condition Q, the closing surface 106b of the second movable member 106 is apart from end portion 112a of the first cavity 112. As a result, the end portion 113a of the second cavity 113 is communicated to the end portion 112a of the first cavity 112.

Next, a manufacturing method for manufacturing an integrally molded article 116 will be explained.

In the first molding condition P shown in FIG. 5, a melted first material 114 is supplied to only the first cavity 112 via a first passage (not shown). Next, in the second molding condition Q shown in FIG. 6, a melted second material 115 is supplied to the second cavity 113 via a second passage (not shown) (refer to FIG. 7). As shown in FIG. 7, the second material 115 in the second cavity 113 is integrally connected with the first material 114 in the first cavity 112. Next, while the movable mold 104 moves downwardly so as to be apart from the fixed mold 103, the second movable member 106 is moved to the lower position A2 by the urging force of the coil spring 111 (refer to FIG. 8). As shown in FIG. 8, in the mold opening condition D, the integrally molded article 116 including the solidified first material 114 and the second material 115 is separated from the second movable member 106. As a result, the integrally molded article 116 can be taken out from the mold. In the second embodiment, the same advantages as the first embodiment shown in FIGS. 1-4 are obtained.

The embodiments may be modified as follows.

The second cavity 13, 113 shown in FIGS. 1-8 may be formed by only the first movable member 5, 105 respectively. In other words, the second cavity 13, 113 is necessarily formed by the first movable member 5, 105. The first cavity 10, 112 may be formed between the second movable member 6, 106 and the body 2 respectively. In other words, the first cavity 10, 112 is necessarily formed by the body 2.

The second movable member 6, 106 shown in FIGS. 1-8 is not necessarily arranged directly on the first movable member 5, 105 respectively. Another member may be arranged between the second movable member 6, 106 and the corresponding first movable member 5, 105.

The second movable member 6, 106 shown in FIGS. 1-8 is necessarily movable with respect to the first movable member 5, 105 respectively, however, the movement direction of the second movable member 6, 106 is not limited.

It should be apparent to those skilled in the art that the present invention may be embodied in many other specific forms without departing from the spirit or scope of the invention. Particularly, it should be understood that the invention may be embodied in the following forms.

Therefore, the present examples and embodiments are to be considered as illustrative and not restrictive and the invention is not to be limited to the details given herein, but may be modified within the scope and equivalence of the appended claims.

1. A mold for molding an integrally molded article using at least two kinds of materials, the mold comprising:
a body for defining a first cavity;
a first movable member for defining a second cavity, wherein the first movable member reciprocates along a predetermined movement axis with respect to the mold; and
a second movable member being movable along the movement axis with respect to the first movable member in the body for selectively connecting and disconnecting the second cavity and the first cavity according to the movement of the second movable member, wherein a first material is supplied to one of the first cavity and the second cavity with the first and second cavities disconnected from each other, and then a second material is supplied to the other one of the first and second cavities with the first and second cavities connected to each other.

2. The mold according to claim 1, wherein the second movable member slides along the first movable member while contacting the first movable member.

3. The mold according to claim 1, wherein the body includes a fixed mold and a movable mold that is movable between a closed position where the movable mold approaches the fixed mold and an open position where the movable mold is apart from the fixed mold, and when the movable mold is in the closed position, the first cavity is formed between the fixed mold and the movable mold:
wherein the first movable member is supported on the movable mold so as to be movable between the closed position and the open position, and when the first movable member is in the closed position, the second cavity is formed between the first movable member and the movable mold; and
wherein the second movable member is supported on the first movable member so as to be movable between a closed position where the first and the second cavities are disconnected from each other and an open position where the first and the second cavities are connected and when the movable mold and the first movable member are in the closed position, the second movable member is selectively in the closed position and the open position.

4. The mold according to claim 3 further comprising an actuator being arranged on the first movable member for moving the second movable member.

5. The mold according to claim 3 further comprising a mechanical movement mechanism being arranged between the fixed mold and the movable mold for moving the first movable member in accordance with the movement of the movable mold.

6. The mold according to claim 5, wherein the movement mechanism includes a pin and a hole, wherein the pin is extended from one of the fixed mold and the first movable member and slanted with respect to the movement direction of the movable mold, and wherein the hole is arranged on the other one of the fixed mold and the first movable member and receives the pin.

7. A mold for molding an integrally molded article using at least two kinds of materials, the mold comprising:
a body for defining a first cavity;
a first movable member for defining a second cavity, wherein the first movable member moves with respect to the mold; and
a second movable member for sliding along the first movable member, while contacting the first movable member in the body, and selectively connecting and disconnecting the second cavity and the first cavity in accordance with the movement of the second movable member, wherein a first material is supplied to one of the first cavity and the second cavity with the first and second cavities disconnected from each other, and then a second material is supplied to the other one of the first and second cavities with the first and second cavities connected to each other.

8. A mold for molding an integrally molded article using at least two kinds of materials, the mold comprising:
a body for defining a first cavity;
a first movable member for defining a second cavity; and
a second movable member being arranged on the first movable member in the body and movable with the first movable member and with respect to the first movable member for selectively connecting and disconnecting the second cavity and the first cavity, wherein a first material is supplied to one of the first cavity and the second cavity with the first and second cavities disconnected from each other, and then a second material is supplied to the other one of the first and second cavities with the first and second cavities connected to each other.

9. A mold for molding an integrally molded article using at least two kinds of materials, the mold comprising:
a body for defining a first cavity;
a first movable member for defining a second cavity being movable with respect to the mold; and
a second movable member being movable in the body so as to be in contact with and apart from the first movable member for selectively connecting and disconnecting the second cavity and the first cavity in accordance with the movement of the second movable member, wherein a first material is supplied to one of the first cavity and the second cavity with the first and second cavities disconnected from each other, and then a second material is supplied to the other one of the first and second cavities with the first and second cavities connected to each other.

10. The mold according to claim 9, wherein the first and the second movable members are movable along a same movement axis.

11. The mold according to claim 9, wherein the body includes a fixed mold and a movable mold that is movable between a closed position, where the movable mold approaches the fixed mold, and an open position, where the movable mold is apart from the fixed mold; and the first movable member is supported on the movable mold so as to move between a lift position and a down position, and the second movable member is supported by the fixed mold so as to be movable between a down position, where the first and the second cavities are disconnected from each other, and a lift position, where the first and the second cavities are connected to each other; and when the first and the second movable members are in the down position, the second cavity is formed between the first and the second movable members, and when the first and the second movable members are in the lift position, the first and the second cavities are connected.

12. The mold according to claim 9, wherein the first and the second movable members each have a facing surface, wherein the two faces face with each other, and a portion of the facing surface of the first movable member and a portion of the facing surface of the second movable member are pressed with each other and the second cavity is defined between portions of the facing surfaces that are not pressed with each other.

13. A manufacturing method for molding an integrally molded article using at least two kinds of materials, the method comprising:
defining a first cavity by approaching a movable mold to a fixed mold;
defining a second cavity by moving a first movable member with respect to the movable mold along a predetermined movement axis to a closed position;
disconnecting a first cavity and a second cavity by moving the second movable member with respect to the first movable member along the movement axis to a disconnecting position while a first and a second cavities are formed;
supplying a first material to one of the first and the second cavities while the second cavity is disconnected from the first cavity;
connecting the first and the second cavities by moving the second movable member from the disconnecting position to an open position;
supplying a second material to the other one of the first and the second cavities while the second cavity is connected to the first cavity; and
releasing the first and the second cavities by separating the movable mold from the fixed mold and moving the first movable member and the second movable member from the closed position to the open position.
